(19) United States
(12) Patent Application Publication
(10) Pub. No.: US 2026/0115895 A1
(43) Pub. Date: Apr. 30, 2026

(54) LOCOMOTION VIA VIBRATION OF SOFT, TWISTED BEAMS WITH AN UNDER-ACTUATED QUADRUPED

(71) Applicants: Daniel Aukes, Gilbert, AZ (US); Yuhao Jiang, Prilly (CN); Fuchen Chen, Mesa, AZ (US)

(72) Inventors: Daniel Aukes, Gilbert, AZ (US); Yuhao Jiang, Prilly (CN); Fuchen Chen, Mesa, AZ (US)

(21) Appl. No.: 19/368,686

(22) Filed: Oct. 24, 2025

Related U.S. Application Data
(60) Provisional application No. 63/711,482, filed on Oct. 24, 2024.

(51) Int. Cl. B25J 9/00; B25J 9/12; B25J 9/16; B25J 13/08

(52) U.S. Cl. CPC B25J 9/0012; B25J 9/126; B25J 9/161; B25J 13/088

(57) ABSTRACT

A lightweight, under-actuated, compliant, quadrupedal robot employing twisted beams as legs, actuated by controllable one-directional vibration force to achieve diverse maneuvering modes. Adjusting the actuator's shaking frequency and direction, the robot can execute various maneuvers such as forward movement, lateral movement, and turning via the coupled, resonant response of the legs. The quadrupedal robot includes a body plate having a shape defining at least four corners; four legs, each leg coupled to one of the at least four corners of the body plate; and a dual-motor actuator coupled to the body plate. The body plate is rigid, and each leg includes a twisted beam formed of a flexible polymeric material.

### CROSS-REFERENCE TO RELATED APPLICATION

This application claims the benefit of U.S. Patent Application No. 63/711,482 filed on Oct. 24, 2024, which is incorporated by reference herein in its entirety.

### STATEMENT OF GOVERNMENT SUPPORT

This invention was made with government support under 1935324 awarded by the National Science Foundation. The government has certain rights in the invention.

### TECHNICAL FIELD

This invention relates to quadrupedal robots that move using twisted beam actuators.

### BACKGROUND

The exploration of legged robots has garnered attention due at least in part to their maneuverability in intricate and cluttered terrains compared to wheeled and tracked counterparts.

### SUMMARY

This disclosure describes a lightweight, under-actuated, compliant, quadrupedal robot employing twisted beams as legs, actuated by controllable one-directional vibration force to achieve diverse maneuvering modes. Adjusting the actuator's shaking frequency and direction, the robot can execute various maneuvers such as forward movement, lateral movement, and turning via the coupled, resonant response of the legs.

In a first general aspect, a robot includes: a body plate having a shape defining at least four corners; four legs, each leg coupled to one of the at least four corners of the body plate; and a dual-motor actuator coupled to the body plate. The body plate is rigid, and each leg includes a twisted beam formed of a flexible polymeric material.

Implementations of the first general aspect include one or more of the following features.

In some cases, the body plate is in the shape of a rectangle. The body plate can include or be composed of carbon fiber. The twisted beam defines a twist angle of about 90° from a first end of each leg to a second end of each leg. A rigid foot is coupled to each twisted beam. A foot pad can be coupled to each rigid foot. In one example, the rigid foot is composed of polylactic acid. In some examples, each twisted beam is coupled to the body plate with a threaded bolt and a nut. In certain examples, each twisted beam is coupled to the corresponding rigid foot with a threaded bolt and a nut. A ratio of a length of the body plate to a length of the twisted beam can be about 5:1.

In some cases, the dual-motor actuator is positioned at a center of the body plate. In one example, the dual-motor actuator is a rotary actuator. The rotary actuator can be configured to generate a shaking force (e.g., a consistent shaking force) in one direction. In certain cases, the dual-motor actuator includes two rotors, and rotary inertia is effectively cancelled out by opposing rotations of the two rotors. The centrifugal force produced by the two rotors peaks when the two rotors are aligned, and nullifies when the two rotors are 180° apart. A first one of the two rotors is typically positioned on a first side of the body plate, and a second one of the two rotors is typically positioned on a second side of the body plate. The first one of the two rotors is coupled to a first one of the motors in the dual-motor actuator, and the second one of the two rotors is coupled to a second one of the motors in the dual-motor actuator.

In some cases, the robot includes a processor coupled to the body plate. In certain cases, the rotor includes one or more rotary position sensors coupled to the body plate. A weight of the robot can be less than 500 grams.

Through simulation and physical model measurements, various maneuvering modes through a range of available control parameters were assessed. Additionally, the impact of internal and external factors on resulting motions were examined to develop metrics to select control parameters for effectively generating locomotion.

To identify suitable actuation parameters, a method for assessing soft curved reconfigurable anisotropic mechanisms (SCRAM) robots' dynamic behavior was utilized. The method includes three steps to assess and select effective actuation pairs for various dynamic motions. Additionally, a metric was devised to aid in the identification of robust actuation pairs.

First, a simplified model is formulated to depict the system's compliant dynamic behavior, followed by parameter calibrations through physical model testing. Second, simulations are used analyze the dynamic behavior across the actuation domain. Third, the candidates for actuation parameters are identified using the proposed metric and are validated and selected through physical model measurements to generate locomotion. This approach capitalizes on the rapidity of simulation, compared to other testing methods, resulting in time savings in the exploration of complex dynamic robotic systems.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a schematic diagram of a quadrupedal robot, with an inset illustrating movement of the legs.

FIG. 2 is a schematic diagram of an example quadrupedal robot.

FIG. 3A is a schematic diagram of an example dual-motor actuation system. FIG. 3B shows a robot simulation model and contact model. FIG. 3C is a schematic diagram of a twisted beam leg. FIG. 3D is a schematic diagram of the robot body.

FIG. 4A shows a schematic diagram of a model with segment number N=3. FIG. 4B shows a schematic diagram of a model with segment number N=(10,50). FIG. 4C shows a schematic diagram of a simulation setup for the dynamic model fitting process. FIG. 4D shows a fitting result comparison.

FIGS. 5A-5D show dynamic modeling results. FIG. 5A shows dynamic modeling of the actuation system in a multi-joint dynamic with contact (MuJoCo) simulator. FIG. 5B shows an illustration of the actuation system showing its offset angle and driving directions. FIG. 5C shows resulting actuation force and torque orientations from various driving directions and offset angles. FIG. 5D shows simulation result of the relationship between the actuation force and the driving frequency.

FIG. 6 shows a MuJoCo model for simulation of different load conditions.

### DETAILED DESCRIPTION

This disclosure describes a quadrupedal robot with twisted beams that can navigate from a directionally controllable vibrational source and whose control parameters are selected to provide reliable operation over a variety of proposed conditions. The magnitude of the shaking force can be regulated by adjusting the driving frequency of the rotors, while the direction of the shaking force can be controlled by manipulating the offset angle of the rotors. These adjustments allow the robot to execute various maneuvers such as forward movement, lateral movement, and turning via the coupled, resonant response of the legs.

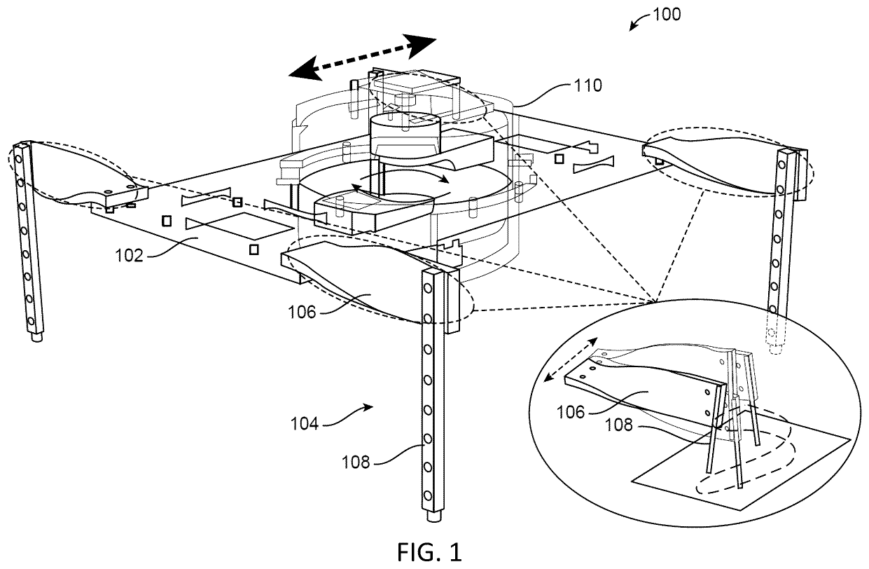

FIG. 1 is a schematic diagram of a quadrupedal robot 100. The quadrupedal robot 100 includes a body plate 102, a plurality of legs 104 including a twisted beam 106 and a rigid foot 108. A dual-motor actuator 110 is coupled to the body plate 102. The inset of FIG. 1 illustrates a leg or the plurality of legs 104 in motion.

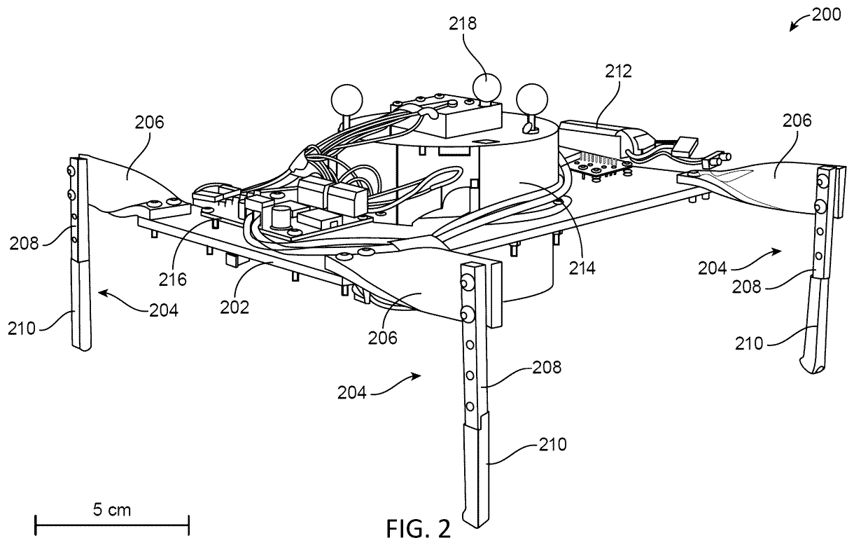

FIG. 2 is a schematic diagram of an example quadrupedal robot 200. The quadrupedal robot 200 includes a body plate 202 having a shape defining at least four corners, four legs, each leg 204 coupled to one of the at least four corners of the body plate 202. The body plate 202 is rigid. The body plate 202 is typically in the shape of a rectangle. The body plate 202 includes carbon fibers.

Each leg 204 includes a twisted beam 206 formed of a flexible polymeric material. Examples of flexible polymeric materials include polyurethane(s), silicone rubber(s), low-density polyethylene(s), plasticized polyvinyl chloride(s), ethylene-vinyl acetate(s), thermoplastic elastomers, natural rubber, latex, and the like. The twisted beam 206 defines a twist angle of about 90° from a first end of the leg 204 to a second end of the leg 204. The quadrupedal robot 200 further includes a rigid foot 208 coupled to each twisted beam 206. The rigid foot 208 typically includes polylactic acid. The twisted beam 206 is coupled to the body plate 202 with a threaded bolt and a nut. The twisted beam 206 is coupled to the rigid foot 208 with a threaded bolt and a nut. The quadrupedal robot 200 further includes a footpad 210 coupled to the rigid foot 208.

The quadrupedal robot 200 further includes a processor coupled to the body plate 202. The quadrupedal robot 200 further includes one or more rotary position sensors coupled to the body plate 202. The quadrupedal robot 200 further includes a battery 212 coupled to the body plate 202. A weight of the quadrupedal robot 200 is less than 500 grams (e.g., 350 grams). The quadrupedal robot 200 further includes a motor driver 206. The quadrupedal robot 200 further includes a plurality of motion tracking markers 218.

A dual-motor actuator 214 coupled to the body plate 202. The dual-motor actuator 214 is positioned at a center of the body plate 202. The dual-motor actuator 214 is a rotary actuator. The rotary actuator is configured to generate a consistent shaking force in one direction.

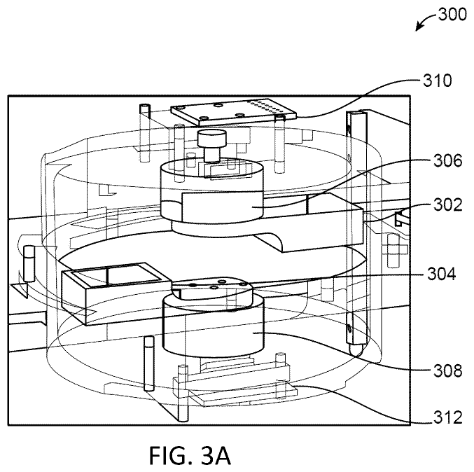

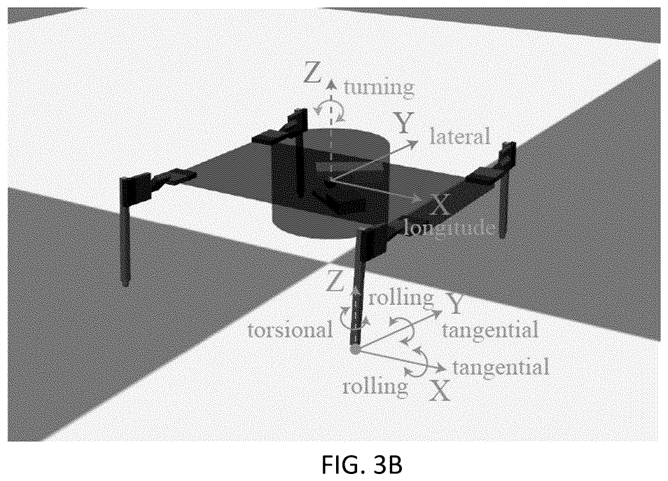

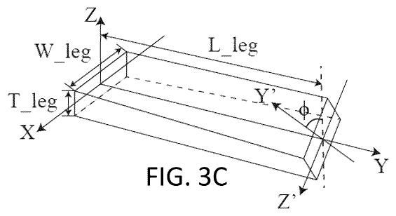

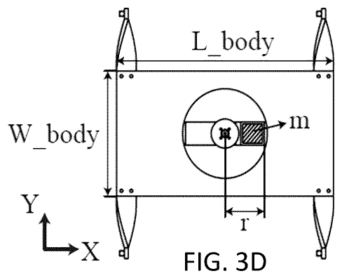

FIG. 3A is a schematic diagram of an example dual-motor actuator 300. The dual-motor actuator 300 includes two rotors, a first rotor 302 and a second rotor 304, and rotary inertia is effectively cancelled out by opposing rotations of the two rotors. A centrifugal force produced by the two rotors peaks when the two rotors are aligned, and nullifies when the two rotors are 180° apart. A first one of the two rotors 302 is positioned on a first side of the body plate, and a second one of the two rotors 304 is positioned on a second side of the body plate. The first one of the two rotors 302 is coupled to a first one of the motors 306 in the dual-motor actuator 300, and the second one of the two rotors 304 is coupled to a second one of the motors 308 in the dual-motor actuator 300. The dual-motor actuator 300 further includes a first encoder 310 and a second encoder 312.

To understand the dynamic behavior of the system under various controlled inputs, a dynamic model based on the Pseudo-Rigid Body Model (PRBM) was developed, which was implemented in a multi-joint dynamic with contact (MuJoCo) simulator and calibrated to reflect the robot's behavior. Through simulations, validated via measurement with a physical model of the robot, actuation parameters were assessed for effective maneuvering and the system's sensitivity to manufacturing and environmental variation was analyzed. The results demonstrate a strategy for understanding the complex relationships guiding robot behavior and for selecting control strategies that are robust across selected variables of interest.

### EXAMPLES

A quadrupedal robot included three sections. First, the robot included a rigid body plate designed to transmit actuation forces. Second, the robot included four twisted-beam legs positioned at the body plate's four corners. Each leg's distal end was attached to a rigid foot, which was 3D printed in polylactic acid (PLA). The robot also included a duo-rotor shaking system situated at the body plate's center to generate actuating forces, as shown in FIG. 3D. Details of the design parameters used can be found in Table 1.

TABLE 1
Design Parameters

| Parameter | Symbol | Value | Unit |
|---|---|---|---|
| Body Plate Length | L_body | 220 | mm |
| Body Plate Width | W_body | 120 | mm |
| Body Plate Thickness | T_body | 3.5 | mm |
| Leg Length | L_leg | 50 | mm |
| Leg Width | W_leg | 20 | mm |
| Leg Thickness | T_leg | 3 | mm |
| Leg Twist Angle | φ | 90 | degree |
| Foot Length | L_foot | 85 | mm |
| Foot Width | W_foot | 5 | mm |
| Rotating Radius | r | 40 | mm |
| Rotor Offset Mass | m | 12 | g |
| Rotor frequency | f | — | Hz |
| Rotor offset angle | θ | — | degree |

The robot body was designed with sufficient rigidity to transmit vibrational power from the shaker to the legs while remaining lightweight to minimize mass and inertia. A 16 g carbon fiber sandwich sheet was used, which was computer numerical control-fabricated to size.

Design parameters of the leg, including a twisted beam, are detailed in FIG. 3C and Table 1. The twisted beam included a 90° twisting angle φ and the dimension of beam thickness T_leg was selected to accommodate the weight and dynamic characteristics of the quadrupedal robot. The twisted beam design offers stiffness to support the robot's weight while preserving anisotropic dynamic behavior for generating walking locomotion. The twisted beam is suitable for 3D printing, and was fabricated from TPU95A5 using an Ultimaker S5 3D printer.

In a quadrupedal robot, an ESP32 microcontroller with a SimpleFOC motor driver was utilized and positioned at the tail of the body plate. Additionally, a 300 mAh, 3-cell Li—Po battery was installed at the front of the body plate to balance out the mass. The overall weight of the robot was 350 grams. Two brushless motors, each with an offset rotary load, were mounted on the top and bottom of the cage. Additionally, two rotary position sensors were situated on the two outer sides of the cage to record motor angular position data.

A model of the quadrupedal robot was developed, which was simulated using multi-joint dynamic with contact (MuJoCo). This model integrated a 3-segment twisted beam model based on the Pseudo-Rigid Body Model (PRBM), and the actuation model. The model included a rigid foot, a rigid body, and an actuator cage, with mass and dimension parameters set as detailed in Tables 1 and 2.

TABLE 2
Model Parameters

| Parameter | Symbol | Value | Unit |
|---|---|---|---|
| Segment amount | N | 3 | — |
| Segment length | L_seg | 12.5 | mm |
| Segment width | W_seg | 20 | mm |
| Segment thickness | T_seg | 3 | mm |
| Segment twist angle | φ_seg | 45 | degree |
| Bending Stiffness | | | |
| Front left leg | k_{bend}_{_{—}}ₗₗ | 0.331919 | — |
| Front right leg | k_{bend}_{_{—}}ₗᵣ | 0.51199 | — |
| Rear left leg | k_{bend}_{_{—}}ᵣₗ | 0.659592 | — |
| Rear right leg | k_{bend}_{_{—}}ᵣᵣ | 0.38034 | — |
| Twisting Stiffness | | | |
| Front left leg | k_{twist}_{_{—}}ₗₗ | 0.474848 | — |
| Front right leg | k_{twist}_{_{—}}ₗᵣ | 1.919435 | — |
| Rear left leg | k_{twist}_{_{—}}ᵣₗ | 1.471505 | — |
| Rear right leg | k_{twist}_{_{—}}ᵣᵣ | 1.363416 | — |
| Bending Damping | | | |
| Front left leg | b_{bend}_{_{—}}ₗₗ | 0.000015 | — |
| Front right leg | b_{bend}_{_{—}}ₗᵣ | 3.648e−07 | — |
| Rear left leg | b_{bend}_{_{—}}ᵣₗ | 0.000099 | — |
| Rear right leg | b_{bend}_{_{—}}ᵣᵣ | 0.000171 | — |
| Twisting Damping | | | |
| Front left leg | b_{twist}_{_{—}}ₗₗ | 0.000015 | — |
| Front right leg | b_{twist}_{_{—}}ₗᵣ | 0.004781 | — |
| Rear left leg | b_{twist}_{_{—}}ᵣₗ | 0.008056 | — |
| Rear right | b_{twist}_{_{—}}ᵣᵣ | 0.005281 | — |
| Center of Mass Offset | | | |
| magnitude | m_{mag} | 1.629 | g |
| x position | mₓ | 9.789 | mm |
| y position | m_{y} | 8.942 | mm |
| Contact Friction | | | |
| Front left leg | fₗₗ | 1.424658 | — |
| Front right leg | fₗᵣ | 0.92752 | — |
| Rear left leg | fᵣₗ | 0.881027 | — |
| Rear right leg | fᵣᵣ | 1.053785 | — |

To enhance the reliability of the model, a fitting process was completed. During the parameter fitting process, initial experiments were conducted using the fabricated quadrupedal robot to gather reference data. These tests involved controlling the robot to move under varied actuation parameters, including driving frequencies f ranging from −35 to 35 and shaking orientations θ spanning from −60° to 90°. A motion capture system was employed to record the robot's pose data. The testing conditions are depicted in FIG. 3B. Subsequently, the same actuation commands applied during the physical model tests were replicated in the simulation, and the resulting pose data was recorded.

For parameter optimization, a Bayesian hyperparameter optimization algorithm was implemented to minimize the objective function. This objective function was defined as the square root of the mean square error between the simulation results and the reference data. Mathematically, the objective function is represented as shown in Equation (1).

$$min \{ \frac{\sqrt{{\sum }_{n = 0}^{N} [ {( {V}_{i} ( n ) - {\hat{V}}_{i} ( n ) )}^{2} + {( ω ( n ) - \hat{ω} ( n ) )}^{2} ]}}{3 N} \} \qquad ( 1 )$$

Here, i∈{x,y} denotes the directions along the x and y axis. Vᵢ (n) represents the linear velocity in simulation along the i axis at time step n, while \hat{V}ᵢ(n) represents the corresponding reference data. Similarly, ω(n) denotes the angular velocity in simulation along the z axis at time step n, and \hat{ω}(n) represents the reference data.

The friction factors for each leg and a body mass offset were also incorporated to account for ground contact conditions and manufacturing variations. The goal parameters for this process are represented as shown in Equation (2).

$$X = ( {k}_{bend \_ fl} , {k}_{bend \_ fr} , {k}_{bend \_ rl} , {k}_{bend \_ rr} , {b}_{bend \_ fl} , {b}_{bend \_ fr} , {b}_{bend \_ rl} , {b}_{bend \_ rr} , {k}_{twist \_ fl} , {k}_{twist \_ fr} , {k}_{twist \_ rl} , {k}_{twist \_ rr} , {b}_{twist \_ fl} , {b}_{twist \_ fr} , {b}_{twist \_ rl} , {b}_{twist \_ rr} , {m}_{mag} , {m}_{x} , {m}_{y} , {f}_{fr} , {f}_{fl} , {f}_{rr} , {f}_{rl} ) \qquad ( 2 )$$

These parameters describe the stiffness (k) and damping (b) properties of bending and twisting joints found in the front-left (fl), front-right (fr), rear-right (rr), and rear-left (rl) feet. They also include the body's mass (m), its offset positions along the x and y axes, and the tangential friction coefficients (f) for the feet (fl, fr, rr, and rl), respectively. The objective function aimed to minimize the disparity between the robot's averaged speeds in the longitudinal direction, lateral direction, and turning in simulation, compared to the corresponding reference data.

The parameters resulting from this process are provided in Table 2. The motion behavior observed in the simulation from the fitted model demonstrated an alignment with the reference test data, demonstrating a correspondence between the simulation model and fabricated quadrupedal robot behavior.

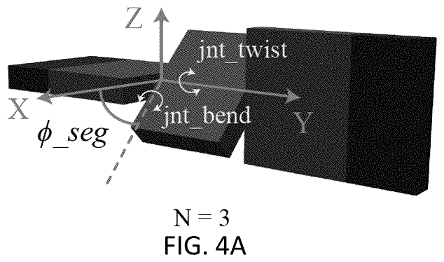

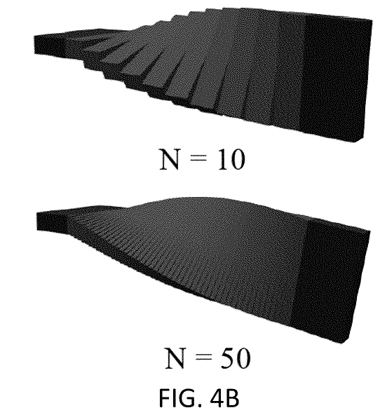

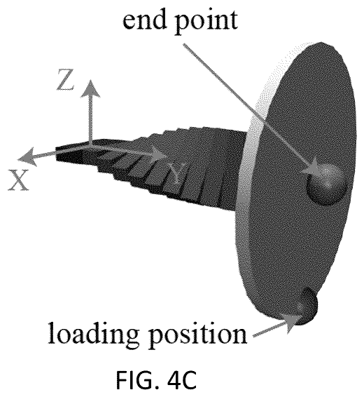

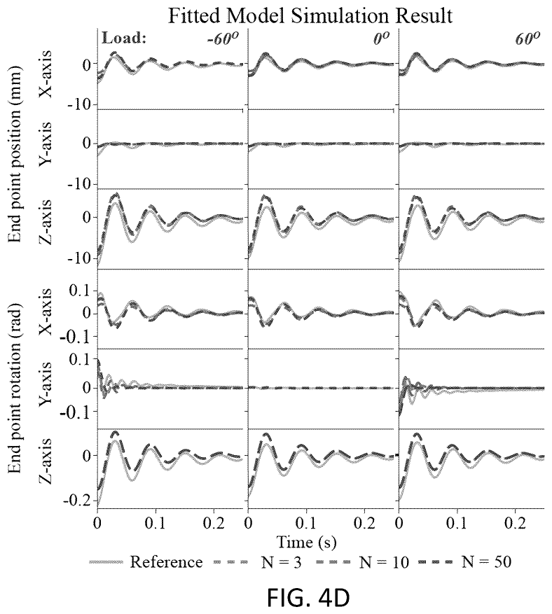

A pseudo-rigid body modeling (PRBM) approach was utilized to model and describe the dynamic behavior of the soft twisted beams due at least in part to its compatibility with rigid body dynamic simulators such as MuJoCo. As shown in FIG. 4A, the beam is evenly segmented into N twisting segments, with each segment connected by two orthogonal revolute joints. One joint aligns with the X-axis to represent bending behavior, while the other aligns with the Y-axis to represent twisting behavior. All bending joints were assigned a uniform set of stiffness and damping parameters, while a separate set was allocated to all twisting joints. This distribution was based on the beam's consistency in terms of width, thickness, and material distribution. In this arrangement, the stiffness of the joints was directly related to the flexural rigidity of the beam and inversely related to the length of each segment.

An optimization-based methodology was utilized to determine single leg model parameters (e.g., k_{bend}, b_{bend}, k_{twist}, b_{twist}), which represent the stiffness (k) and damping (b) parameters for the pseudo-rigid bending and twisting joints, respectively. To identify these parameters, a series of measurements was conducted using a twisted beam with dimensions described in Table 1. In these measurements, the beam was deflected to one side, with a load attached to its distal end. Subsequently, the load was removed, and the resulting recovery movement of the beam's distal end was recorded using a motion capture system. This procedure was repeated three times under different loading conditions: with the load positioned at −60°, vertically at 0°, and at 60°. The data collected from these tests served as a reference for parameter fitting. The loading and removal process was replicated in MuJoCo simulation, as shown in FIG. 4C. The corresponding end point pose during recovery was recorded in the simulation.

For parameter optimization, the optimization algorithm was also utilized to minimize the objective function. This objective function was defined as the square root of the mean square error between the simulation results and the reference data. Mathematically, the objective function is represented as shown in Equation (3).

$$min \{ \frac{\sqrt{{\sum }_{n = 0}^{N} [ {( {P}_{i} ( n ) - {\hat{P}}_{i} ( n ) )}^{2} + {( {R}_{i} ( n ) - \hat{{R}_{i}} ( n ) )}^{2} ]}}{6 N} \} \qquad ( 3 )$$

Here, i∈{x,y,z} denotes the directions along the x, y, and z axis. Pᵢ(n) represents the position data in simulation along the i axis at time step n, while \hat{P}ᵢ(n) represents the corresponding reference data. Similarly, Rᵢ(n) denotes the rotational data in simulation along the i direction at time step n, and \hat{R}ᵢ(n) represents the reference rotational data.

To assess the impact of segment number on the resulting fitting, a series of simulations was conducted with varying beam model segment numbers, specifically N E {3, 10, 50}, as shown in FIGS. 4A and 4B. The fitting results are shown in FIG. 4D. The corresponding minimum error for each N was e=(0.018719, 0.018552, 0.018565), respectively. Additionally, the time lapsed for one iteration of these simulations using a workstation computer for each N was t=(0.2711, 0.8648, 23.6518) seconds, respectively. These results suggested that the modeling approach reproduced the dynamic characteristics of the twisted beam. Moreover, the results also suggested that increasing the segment number had negligible impact on the precision of the simulation results, while it did increase the simulation time. Therefore, N=3 was used for the beam model in the simulations.

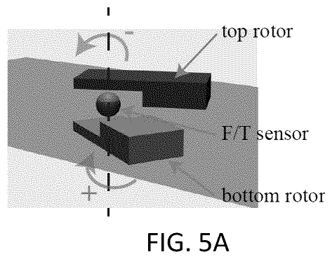

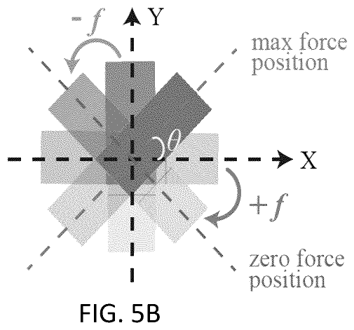

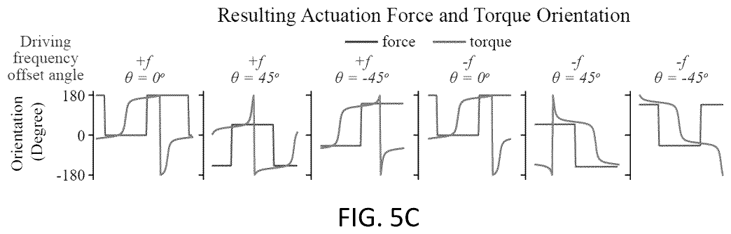

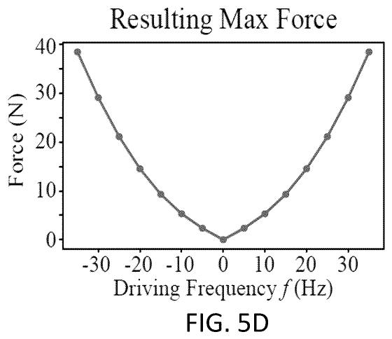

FIG. 5A shows dynamic modeling of the actuation system in MuJoCo. The robot utilized a dual-motor actuation system to generate unidirectional vibrational force. Two motors were mounted at the geometric center of the body plate inside a protective cage. These motors shared a common axis, each with an equivalent off-axis mass m mounted about the shaft. As the system rotates, it generates a consistent shaking force in one direction, with the rotary inertia mostly canceled out by the opposing rotations of the two rotors.

As shown in FIG. 5B, the centrifugal forces produced by the two masses constructively add together in the direction of their shared motion and are mostly canceled out along the orthogonal direction. The angle θ, as shown in FIG. 5B, represents the rotational offset between the body's sagittal plane and the direction of the maximum force, with θ∈[−90, 90] degrees. Positive and negative values of θ denote the direction of the shaking force, with positive values indicating the right-hand side of the robotic body and negative representing the left-hand side. When θ=0°, the peak force is aligned with the robot's heading direction (X-axis in FIG. 5B), whereas θ=(−90, 90) degrees indicates that the peak force is aligned with the robot's lateral direction (Y-axis in FIG. 5B). The driving frequency f represents the rotational frequency of the top rotor. A positive value indicates clockwise rotation, while a negative value indicates counterclockwise rotation, as shown in FIG. 5B. The bottom rotor shares the same magnitude of frequency but rotates in the opposite direction. The rotary inertia from each rotor is nearly annulled due at least in part to the synchronized, opposing rotation, though the small misalignments of the two masses along the motors' axes exert small amounts of nonzero rotational momentum on the body. The rotor's offset weight m was 12 g and it was located 28 mm away from the shaft's axis.

The actuation system was analyzed through modeling and simulation in MuJoCo to assess the dynamic forces and torques generated by the system. The model used for these simulations is shown in FIG. 5A. In this model, the two rotors included closely match the fabricated quadrupedal robot, utilizing the design parameters outlined in Table 1. These rotors are affixed to a rotational joint, while a force and torque sensor was included at the joint. During the simulation process, the two rotors were commanded to rotate at specific frequencies and offset angles θ; the resulting force and torque were recorded. Referring to FIG. 5C, the resulting force and torque orientations corresponding to actuation frequencies f={−10, 10} Hz and offset angles θ={−45, 0, 45} degrees show how control inputs generate specific shaking forces. The results show that the actuation system generates unidirectional shaking forces as intended. Additionally, the offset angle θ determined the direction of the shaking force. The relationship between the driving frequency and the maximum shaking force is shown in FIG. 5D. These results demonstrated that the magnitude of the shaking force can be regulated by adjusting the driving frequency of the rotors, while the direction of the shaking force can be controlled by manipulating the offset angle of the rotors. Referring to FIG. 5C, a shaking torque, with its axis of rotation altering within the X-Y plane as f and θ change, was observed. This phenomenon can be attributed at least in part to the momentum exchange between the two rotors. As a result of the dynamically altering torque, the robot's body plate tilted, causing the corners of the body plate to lift and drop sequentially. This action contributed to the robot's legs making or breaking contact with the ground. The combined effect of the shaking force, along with the altering torque, generated the dynamic locomotion of the robot.

The dynamic behavior of underactuated systems can exhibit sensitivities to differences in model parameters that can impact footfall timing or gaits. The underactuated system's internal variation factors (e.g., mass distribution) and external variation factors (e.g., ground contact friction) were assessed. A simulation-based approach was utilized to assess a range of behavior differences across the control space resulting from internal variation. The results were utilized to aid in the selection of the control parameters for testing of the fabricated quadrupedal robot.

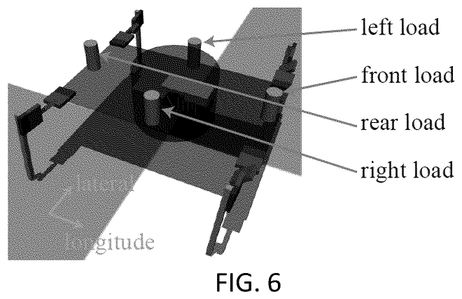

Through both simulation and physical model measurements, the dynamic behavior of the quadrupedal robot's susceptibility to various factors that stem from internal variation was assessed. This variation can arise from issues such as mass distribution differences during assembly and variation in beam stiffness due at least in part to inconsistencies during 3D printing. Using the fitted model within the MuJoCo simulator, a series of simulations under various mass distribution conditions was conducted. This involved adding an extra 50 g load to different locations on the robot body, specifically along the front, rear, left, and right edges of the main body, with their centers 12 mm from the edge, as shown in FIG. 6. The range of variation was selected to represent a payload whose center of mass is poorly aligned with that of the robot. The actuation parameters were systematically varied across a range of values: f ranged from −35 to 35 Hz and θ spanned from −90° to 90°. The motion analysis focused on the robot's average speed in three directions: along the longitudinal axis (X-axis in FIG. 3B), along the lateral axis (Y-axis), and the rotational speed about the Z-axis. The data was obtained from an 8-second simulation. Varying the payload distribution impacted robot behavior across the various directions. Adding mass to the left or right sides of the robot impacted the robot's predicted speed in all directions.

Comparing the longitudinal speed at actuation pairs (f=−35 Hz, θ=60°) and (f=35 Hz, θ=−60°), for example, demonstrated that adding mass to either side disrupted the behavior relative to θ observed in the baseline reference data. Adding mass to the left side resulted in peak longitudinal speed at θ=60°, whereas adding mass to the right side removed that peak at θ=60°. This suggested that modifying the mass distribution along the robot's lateral direction impacted longitudinal speed.

The lateral speed with actuation parameters (f=−35 Hz, θ=0°), and (f=35 Hz θ=0°) was compared. When mass was added to the left side, the lateral speed increased in the negative lateral-axis direction, indicating a tendency for the robot to move to the left. Conversely, when the mass was shifted to the right side, the lateral speed increased in the positive lateral-axis direction, indicating a tendency for the robot to move to the right. This suggested that modifying the mass distribution along the robot's lateral direction also impacted lateral speed.

The turning speed can also be impacted by changes in mass distribution along the robot's lateral direction. When comparing the turning speed under the actuation pairs (f=−30 Hz, θ=−60°), and (f=−30 Hz, θ=−60°), shifting the center of mass to the left resulted in the turning speed to increase in the negative direction of the Z-axis, whereas moving mass distribution to the right resulted in an increase in turning speed in the positive direction of the Z-axis.

Adding mass to the front or rear sides of the robot resulted in change in the turning speed and longitude speed, while both the longitude and lateral speed showed negligible change. Comparing the resulting turning speed data under the actuation parameters (f=−35 Hz, θ=−30°) and (f=35 Hz, θ=30°) showed that adding mass to either the robot's front or rear can increase the turning speed in both directions.

In addition to mass distribution variations, actuation parameter pairs that lead to robust motion outcomes despite these errors were assessed. Both the speed deviation and the effectiveness of these actuation pairs were analyzed under mass variations, utilizing an actuation performance index.

The index I is determined by calculating the root mean squared error between the velocity in three directions separately of the robot under each mass loading condition (V_{load}) and a reference, non-variant speed (V_{ref}) at each (f, θ) pair, as shown in Equation (4):

$$\overline{E} = \sqrt{\frac{1}{N} {\sum }_{i = 1}^{N} {( {V}_{load , i} - {V}_{ref , i} )}^{2}} \qquad ( 4 )$$

where N is the total number of mass loading conditions. The corresponding reference speed (V_{ref}) is divided by this averaged error to generate the index for that specific direction, as shown in Equation (5):

$$I = \frac{{V}_{ref}}{\overline{E}} \qquad ( 5 )$$

This metric increases when both the error is minimal and the reference speed is high and showed actuation commands (f, θ) that result in resilience to mass distribution variations.

External factors, such as contact friction, also played a role in the resulting dynamic behavior of the quadrupedal robot. A series of simulations was conducted to measure the effect of these factors. A simulation setup as depicted in FIG. 3B was utilized. The contact model included two-directional tangential friction, two-directional rolling friction, and one-directional twisting friction. Among these, tangential friction plays a primary role in influencing motion outcomes. The friction was adjusted for each leg by altering the contact tangential friction coefficients. The non-bias friction factor, denoted as (f_{fr}, fᵣₗ, fᵣᵣ, fᵣₗ)=(1.067144, 1.551115, 0.961013, 1.232479), is determined through the fitting process. Throughout the simulations, friction parameter offsets were introduced as percentages of this non-bias friction factor. The simulation systematically varies the friction percentage within the range of {+10%, +58%} with driving frequencies f ranging from −35 to 35 Hz and driving offset angle θ spanning from −90° to 90°. The +58% friction variation was determined based on the measured friction difference between the quadrupedal robot with and without the footpad, altering the contact friction coefficient from 0.62 (with the footpad) to 0.26 (without the footpad).

To assess how changes in floor contact friction affect resulting motion, two sets of simulation data were analyzed. The longitudinal speed across different friction conditions were compared. Lower friction led to asymmetrical speed patterns, demonstrated by longitudinal speeds at actuation pairs {f=35 Hz, θ=−60° } and {f=−35 Hz, θ=60°}, whereas higher friction resulted in symmetrical speed behavior. The side with the lower friction level provided the actuation frequency that resulted in peak longitudinal speed. A-10% friction reduction on the left side resulted in peak speed at frequency f=−35 Hz, whereas the same-10% friction reduction on the right side resulted in peak speed occurring at frequency f=35 Hz.

The impact of friction changes on lateral speed was assessed. Comparison of friction errors applied to the left and right sides showed that side friction errors affect the robot's lateral speed. The lateral speed increased on the side with lower friction. Additionally, differences in side friction influenced the peak lateral speed. When a friction offset of −30% was applied to the left side, the lateral speed peaked in the positive Y-axis direction at the actuation pair f=35 Hz, θ=0°, whereas with a −30% friction offset applied to the right side, the lateral speed peaks in the negative Y-axis direction at the actuation pair f=−35 Hz, θ=0°.

The influence of friction changes on turning speed were assessed. Introducing friction errors to one side resulted in an increase in directional turning speed. With a friction error of −10% added to the left side, the turning speed in its direction about the positive z-axis increased at the actuation pair f=30 Hz, θ=60°; whereas when the same friction error is added to the right side, the turning speed in its direction about the negative z-axis increased at the actuation pair f=−30 Hz, θ=−60°.

Actuation parameter pairs that are robust against the impacts induced by side friction errors were identified through a series of simulations. The impact of various variations developed by both internal differences and external factors were assessed. These errors demonstrated an impact on the robot's motion in simulation. Based on the results of the simulations, a metric was developed to assist in selecting actuation inputs that can provide locomotion that remains stable during error conditions.

The quadrupedal robot includes five distinct locomotion modes: forward maneuver, left turn, right turn, left transition, and right transition. Each mode can be characterized by the speed in three directions: longitudinal speed, lateral speed, and turning speed. In the forward maneuver mode, the robot should exhibit a high longitudinal speed with negligible lateral and turning speeds. Conversely, in turning modes, the robot should exhibit high turning speed alongside lower longitudinal and negligible lateral speeds. In transition modes, the robot prioritizes higher lateral speed with lower longitudinal speeds and near-zero turning speed.

To identify actuation parameter candidates that generate the desired movements while remaining resilient to error conditions, an index P was introduced to assess the overall effectiveness and robustness of the actuation pairs. First, actuation pairs were filtered to exclude those that fail to generate adequate forward locomotion, specifically those with a heading speed lower than 0.05 m/s. The actuation performance index was calculated by averaging the summed index I′ from the filtered mass distribution error analysis and the friction error analysis, as shown in Equation (6):

$$P = \frac{{I}_{mass}^{′} + {I}_{friction}^{′}}{2} \qquad ( 6 )$$

Similar to I, this index yields high values when the speed is high, and the error is low. The actuation pairs for forward maneuvering focused on prioritizing high longitudinal speed and low lateral and turning speeds based on the metric.

Initially, a set of measurements was conducted to evaluate how various factors, including load distribution errors, ground contact friction errors, and ground inclinations, affect the resulting motion. Subsequently, two untethered closed loop control tasks were completed to demonstrate the maneuverability of the quadrupedal robot.

A series of measurements was conducted to examine and validate the mass distribution error sensitivity analysis. A 50 g load was attached to the left side of the robot. The untethered robot was commanded with actuation inputs f≡31 (−35, −30, −25, −20, 20, 25, 30, 35) Hz, and offset angle θ € (−90, −60, −30, 0, 30, 60, 90) degrees. A motion capture system was implemented to record the position and pose of the robot. The data was processed to yield the averaged speed in longitude, lateral, and turning. A comparison between the measurements and the simulation showed that the simulation qualitatively captured the trend and behavior of the robot's motion.

Measurements were also conducted to assess the effect of contact friction differences between the left and the right side of the robot. The footpad was removed from both left-side feet, resulting in lower friction compared to the right side. The friction coefficients for the left and right sides were measured to be 0.26 and 0.62, respectively. Subsequently, the robot was commanded to move freely within the test space using identical actuation inputs of f∈(−35, −30, −25, −20, 20, 25, 30, 35) Hz, and the same offset angle θ € (−90, 60, −30, 0, 30, 60, 90) degrees. Although the simulation effectively reproduced the qualitative dynamic behavior of the robot in terms of the shape of regions, a quantitative disparity was observed. This discrepancy could be attributed at least in part to model overfitting.

Several control parameter pairs were identified for actuators that effectively produce functional motions. The outcomes are presented in Table 3. To demonstrate the robustness of the selected control parameters, the robot's motion under varying contact conditions were tested by using the same control parameters to drive the robot walking without the left side foot pads. Removing the left foot pads reduced the contact friction on the left legs by 58%. The control parameters exhibit robustness against variations in motion patterns such as maneuvering forward, turning left, turning right, and left transition, while there was a difference in the right transition motion.

TABLE 3
Control Table

| | Driving | | |
|---|---|---|---|
| | Frequency | Driving | Indices in |
| Motion Pattern | (f Hz) | Offset (θ°) | FIG. 8 |
| Forward Maneuver | 30 | −60 | A |
| Left Turn | −30 | ±90 | E |
| Right Turn | 30 | ±90 | F |
| Left Transition | 35 | 0 | D |
| Right Transition | −30 | −60 | C |

Two untethered maneuver tasks using a closed-loop controller with the control parameters from Table 3 were completed to demonstrate the maneuvering capability of the proposed robot. A closed-loop 2-step bang-bang feedback controller using turning control parameters derived from Table 3 to achieve an ‘8’ pattern trajectory tracking task was implemented. The robot operated wirelessly and its position was tracked using an Optitrack system, with the pose data transmitted to a computer. The control signal was processed on the computer and sent to the robot via WiFi in real-time.

The controller compared the error A between the robot's current heading angle ω and the desired heading \hat{ω} and determined switching between two states. The controller's representation is as shown in Equation (7).

$$u = \{ \begin{matrix}{u}_{left} , & Δ > 0.1 rad \\ {u}_{right} , & Δ < - 0.1 rad\end{matrix} \qquad ( 7 )$$

where u_{left}=(f=−30, θ=90), u_{right}=(f=30, θ=90). The trajectory obtained from the Optitrack system demonstrated that the robot accurately follows the desired trajectory.

The self-navigating capability of the quadrupedal robot was demonstrated by using the same controller to return the robot back to a specified origin. The robot was randomly disturbed and pushed away from its original position. The robot effectively demonstrated its capability to autonomously navigate back to the origin using the same closed loop controller as described in Equation (7).

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A robot comprising:
a body plate having a shape defining at least four corners, wherein the body plate is rigid;
four legs, each leg coupled to one of the at least four corners of the body plate, wherein each leg comprises a twisted beam formed of a flexible polymeric material; and
a dual-motor actuator coupled to the body plate.

2. The robot of claim 1, wherein the body plate is in the shape of a rectangle.

3. The robot of claim 1, wherein the body plate comprises carbon fiber.

4. The robot of claim 1, wherein the twisted beam defines a twist angle of about 90° from a first end of each leg to a second end of each leg.

5. The robot of claim 1, further comprising a rigid foot coupled to each twisted beam.

6. The robot of claim 5, wherein the rigid foot comprises polylactic acid.

7. The robot of claim 1, wherein the dual-motor actuator is positioned at a center of the body plate.

8. The robot of claim 1, wherein the dual-motor actuator is a rotary actuator.

9. The robot of claim 8, wherein the rotary actuator is configured to generate a shaking force in one direction.

10. The robot of claim 8, wherein the dual-motor actuator comprises two rotors, and rotary inertia is effectively cancelled out by opposing rotations of the two rotors.

11. The robot of claim 10, wherein centrifugal force produced by the two rotors peaks when the two rotors are aligned, and nullifies when the two rotors are 180° apart.

12. The robot of claim 10, wherein a first one of the two rotors is positioned on a first side of the body plate, and a second one of the two rotors is positioned on a second side of the body plate.

13. The robot of claim 12, wherein the first one of the two rotors is coupled to a first one of the motors in the dual-motor actuator, and the second one of the two rotors is coupled to a second one of the motors in the dual-motor actuator.

14. The robot of claim 1, further comprising a processor coupled to the body plate.

15. The robot of claim 1, further comprising one or more rotary position sensors coupled to the body plate.

16. The robot of claim 1, wherein a weight of the robot is less than 500 grams.

17. The robot of claim 1, wherein each twisted beam is coupled to the body plate with a threaded bolt and a nut.

18. The robot of claim 5, wherein each twisted beam is coupled to the corresponding rigid foot with a threated bolt and a nut.

19. The robot of claim 5, further comprising a footpad coupled to each rigid foot.

20. The robot of claim 1, wherein a ratio of a length of the body plate to a length of the twisted beam is 5:1.
